(19) United States
(12) Patent Application Publication
(10) Pub. No.: US 2002/0024706 A1
(43) Pub. Date: Feb. 28, 2002

(54) Multiple-wavelength amplified telecommunications system with gain compensation

(76) Inventor: Fausto Meli, Piacenza (IT)

Correspondence Address: Svetlana Short, Corning Incorporated, SP-TI-3-1, Corning, NY, 14831, US

(21) Appl. No.: 09/848,905

(22) Filed: May 4, 2001

Related U.S. Application Data
(60) Provisional application No. 60/107,389, filed on Nov. 6, 1998.

(51) Int. Cl. H04B 10/00; H04B 10/12

(52) U.S. Cl. 359/173; 359/161

(57) ABSTRACT

Optical telecommunications system, comprising: a station (1) for transmitting optical signals, comprising a transmission signal generator (2), capable of generating at least two signals at wavelengths lying within a band of predetermined width, and a multiplexer (3) of the optical signals; a station (8) for receiving the optical signals; and an optical fibre line connecting the said multiplexer of the transmission station to the receiving station. The optical fibre line includes at least one optical amplifier (7) comprising at least one fibre (12) doped with a rare earth, at least one source of pumping radiation (14) for the said doped fibre, and a gain stabilization circuit. The gain stabilization circuit comprises: a separator of the transmission signals from the spontaneous emission of the amplifier, connected after the doped fibre and capable of sending the transmission signals to the output of the amplifier and the spontaneous emission to a further output, and a loop circuit for the re-circulation of the said spontaneous emission collected from the said further output and re-injected before the said doped fibre of the amplifier.

### RELATED APPLICATIONS

This application claims the benefit of U.S. Provisional patent application No. 60/107,389, filed Nov. 6, 1999.

### FIELD OF INVENTION

The present invention relates to a telecommunications system including optical amplifiers, particularly suitable for wavelength division multiplexing, or WDM, transmission.

### TECHNICAL BACKGROUND OF THE INVENTION

For wavelength division multiplexing, or WDM, transmission, it is necessary to send a plurality of transmission signals which are independent of each other along the same line, consisting of optical fibres, by multiplexing in the domain of the optical wavelengths; the transmitted signals may be either digital or analog and are distinguished from each other in that each of them has a specific wavelength, separate from that of the other signals.

The implementation of this WDM transmission requires the allocation of specific wavebands of predetermined width, called “channels” in the following text, to each of the signals having different wavelengths.

Each of these signals, identified in the following text by a wavelength value, called the central wavelength of the signal, has a certain spectral amplitude about the central wavelength value, which depends, in particular, on the characteristics of the laser which is the source of the signal and on the modulation imparted to it to associate a data item with the signal. Typical values of spectral amplitude of the signal emitted by a laser, in the absence of modulation, are around 10 MHz; in the presence of an external modulation, at 2.5 Gbit/s for example, the spectral amplitude is approximately 5 GHz.

For the purpose of transmitting signals in a large number of channels, making use of what is called the third transmission window of silica glass fibres and of the pass band of the optical amplifiers (typically from 1525 to 1620 nm, particularly from 1535 to 1561 nm), the wavelength separation between the signals is conveniently of the order of nanometers or fractions of nanometers.

In this type of transmission, it is advantageous for the different channels to be made substantially equivalent to each other in terms of power levels, signal quality, signal-to-noise ratio and binary error rate (BER).

Where amplifiers, particularly optical amplifiers, are present, these are required to have a substantially identical response for all the transmitted channels; additionally, in order to transmit a large number of channels, the band in which the amplifier can operate has to be wide.

Optical amplifiers are based on the properties of a fluorescent dopant, particularly erbium, introduced as a dopant into the core of an optical fibre; this is because erbium, when excited by the application of pumping light energy, has a high emission in the wavelength range corresponding to the band of minimum attenuation of light in silica-based optical fibres.

When a light signal having the wavelength corresponding to this high emission passes through a fibre doped with erbium and maintained in the excited state, the signal causes the excited erbium atoms to shift to a lower level, with stimulated light emission at the wavelength of the signal, thus producing amplification of the signal.

The decay of the erbium atoms from the excited state also occurs spontaneously, and this generates a random emission which forms a “background noise” which is superimposed on the stimulated emission corresponding to the amplified signal.

The light emission generated by the injection of pumping light energy into the “doped”, or active, fibre may take place at a plurality of wavelengths typical of the doping substance, thus producing a spectrum of fluorescence of the fibre.

For optical telecommunications, in order to achieve maximum amplification of a signal by means of a fibre of the aforesaid type, combined with a high signal-to-noise ratio suitable for correct reception of the signal, use is normally made of a signal generated by a laser emitter, with a wavelength corresponding to the peak, in the specified band, of the curve of the fluorescence spectrum of the fibre incorporating the doping substance used, or the emission peak.

In “Electronics Letters”, 28 March 1991, vol. 27, No. 7, pp. 560-561, there is a description of an erbium-doped optical fibre amplifier, provided with an optical feedback loop, in which a portion of the spontaneous emission (ASE) is coupled to the output of the amplifier, filtered at a selected wavelength, attenuated and finally reinjected at the input of the amplifier, which therefore has a laser loop configuration, in which a single wavelength, different from the transmission wavelength, is fed back. The conditions of oscillation (“lasing”) are controlled by tuning the selected wavelength and varying the attenuation of the feedback loop.

In this condition, the gain for signals at any wavelength other than that of the oscillation in the laser loop is independent of the input power of all the optical channels.

The device described, as well as the devices described in the publications cited below, causes significant attenuation in the transmission channels, since a fraction of these is extracted together with the spontaneous emission and is eliminated in the laser loop, and this introduces a significant gain penalty, indicated as 4-8 dB in the experiment described.

The Applicant has also observed that, since a single wavelength is fed back in the loop, and this wavelength is different from that of the signals used, the portion of signal (including the spontaneous emission, ASE) to be extracted must be sufficiently large, particularly in cases where the wavelength selected for feeding back in the loop is not that of the maximum gain (emission peak).

U.S. Pat. No. 5,088,095, held by the author (M. Zirngibl) of the article cited above, describes an optical fibre amplifier with stabilized gain, in which a feedback loop is connected between the input port and the output port of an optical fibre doped with a rare earth and pumped by a laser. A narrow band filter enables a selected wavelength of spontaneous emission of the amplifier, different from the pump and signal wavelength, to pass from the output of the amplifier to its input.

U.S. Pat. No. 5,128,800, held by the same author (M. Zirngibl), describes an optical fibre amplifier with switchable gain, in which a feedback loop is connected between the input port and the output port of the amplifier, with a configuration similar to that of the preceding item; this loop comprises a non-linear dissipation means, with homogeneous line broadening (“homogeneously broadened”).

The application of a signal at a wavelength other than that selected for the feedback loop switches the gain curve.

Interference filters and isolators may be used in the loop to select the wavelengths transmitted in this portion of the device.

U.S. Pat. No. 5,155,780, also held by the same author (M. Zirngibl), describes an optical limiting amplifier, which supplies at its output a substantially constant power signal for input signals of variable power, in which a signal at variable power is divided into two signals; the first signal is supplied to an amplifier in a first, “forward”, direction and the other is supplied in the opposite direction, after passing through a saturable absorber.

Since the signal leaving the saturable absorber varies more widely than that at its input, the saturation of the amplifier caused by the signal in the “backward” direction keeps the amplifier output power constant, independently of the input power.

U.S. Pat. No. 5,239,607, held by V. L. da Silva et al., describes an optical amplifier with a flattened gain spectrum, in which the amplifier is arranged to operate as a loop laser, with an isolator connected in the loop, permitting propagation in the loop only in the direction opposite that of the signal to be amplified.

The gain is fixed at a value determined by the losses in the loop.

In IEEE Photonics Technology Letters, vol. 3, No. 5, May 1991, pp. 453-455, there is a description of an erbium-doped fibre amplifier (EDFA) in which an error signal is generated by fluctuations of the ASE, monitored at a given wavelength λ_{ref} of the output spectrum of the EDFA. This signal is used to modulate the intensity of a compensation signal at a wavelength λ_{comp} which is injected at the input of the amplifier, and which is used to keep the saturation level constant in the amplifier.

U.S. Pat. No. 5,283,686, held by D. R. Huber, describes an optical system comprising an amplifier and a filter for removing unwanted emission from the amplified optical signal. In a preferred embodiment, the filter consists of an optical circulator and a Bragg grating reflector.

The applicant observes that the use of Bragg grating devices to control the gain of an amplifier in a multiple-wavelength system is not considered in this publication.

U.S. Pat. No. 5,598,491, held by J. Ohya, describes an optical transmission system within which there is an optical amplifier which comprises a selector for selecting part of the spontaneous emission, generated in the erbium-doped fibre present in the amplifier, which has a wavelength lower than that of the amplified signal.

This portion of the spontaneous emission is re-injected at the input of the amplifier to keep the gain of the amplifier substantially constant with variations of the power and wavelength of the input signal.

The applicant has observed that, in amplifiers with gain stabilized by a feedback loop according to the prior art, the stabilization is achieved at the cost of a significant increase in the noise figure. In particular, the applicant has observed that the noise figure of these amplifiers increases with a decrease in the attenuation along the feedback loop.

### SUMMARY OF THE INVENTION

According to an aspect of the present invention, it was found that, if all the wavelengths other than those of the channels whose transmission is required are extracted from the output signal of the amplifier, the spontaneous emission of the amplifier (ASE) was completely removed from the amplifier output signal. If this emission is re-injected at the input of the amplifier it is possible to form a loop laser system oscillating at a wavelength different from that of the transmitted channels.

In this way, the gain in all the channels is kept substantially constant, even when a variable number of these channels is present in the amplifier. This is because the level of ASE circulating in the loop is regulated in a substantially automatic way in relation to the number of channels present, and the ASE absorbs the excess pump power which would be available if any of the channels were absent, leaving for the channels present an available pump level which is substantially constant in all conditions.

Moreover, the substantially complete re-circulation of the ASE in the feedback loop makes it possible to stabilize the gain effectively in the presence of a high attenuation, more than 20 dB for example, along the feedback loop.

A first aspect of the present invention relates to an optical telecommunications system, comprising:

a station for transmitting optical signals, comprising a transmission signals generator, capable of generating at least two signals at wavelengths lying within a band of predetermined width, and a multiplexer of the said optical signals;

a station for receiving the said optical signals;

an optical fibre line connecting the said multiplexer of the transmission station to the said receiving station;

the said optical fibre line including at least one optical amplifier comprising at least one fibre doped with a rare earth, at least one source of pumping radiation for the said doped fibre, and a gain stabilization circuit,

characterized in that the said gain stabilization circuit comprises:

a separator of the transmission signals from the spontaneous emission of the amplifier, connected after the said doped fibre and capable of sending the said transmission signals to one output of the amplifier and the said spontaneous emission to a further output;

a loop circuit for the re-circulation of the said spontaneous emission taken from the said further output and re-injected before the said doped fibre of the amplifier.

According to an embodiment of the present invention, the signal separator comprises an optical circulator, connected after the doped fibre of the amplifier by a connecting fibre and to the output port of the amplifier by a connecting fibre opposite to the previous one, and having an intermediate connecting fibre connected to a selective reflection filtering station which reflects along the said fibre the signals having wavelengths equal to those of the transmission signals and sends the remaining radiation to the said loop circuit.

According to an embodiment of the present invention, the loop circuit comprises a length of optical fibre having one end connected to the output of the said filtering station and the other end connected, through a coupler, before the doped fibre of the amplifier.

According to one embodiment, the loop circuit comprises a variable attenuator connected along the length of fibre.

According to an embodiment of the present invention, the filtering station comprises at least one selective reflection filter, tuned to one or more wavelengths of the said at least two transmission signals.

A further aspect of the present invention relates to an optical amplifier comprising:

an input port for an optical signal to be amplified;

at least one fibre doped with a rare earth;

at least one source of pumping radiation for the said doped fibre;

an output port for an amplified signal; and

a gain stabilization circuit,

characterized in that the said gain stabilization circuit comprises:

a separator of the amplified signal from the amplified spontaneous emission, connected after the said doped fibre and capable of sending the said transmission signal to the output port of the amplifier and sending the said spontaneous emission to a further output;

a loop circuit for re-circulating the said spontaneous emission taken from the said further output and re-injected before the said doped fibre of the amplifier.

According to an embodiment of the present invention, the signal separator comprises an optical circulator, connected after the doped fibre of the amplifier by a connecting fibre and to the output port of the amplifier by a connecting fibre opposite to the previous one, and having an intermediate connecting fibre connected to a selective reflection filtering station which reflects the signals having wavelengths equal to those of the transmission signals to the intermediate connecting fibre, and sends the remaining radiation to the said loop circuit.

According to an embodiment of the present invention, the loop circuit comprises a length of optical fibre having one end connected to the output of the said filtering station and the other end connected, through a coupler, before the doped fibre of the amplifier.

According to one embodiment, the loop circuit comprises a variable attenuator connected along the length of fibre.

According to an embodiment of the present invention, the filtering station comprises at least one selective reflection filter, tuned to the wavelength of the signal to be amplified.

A further aspect of the present invention relates to an optical telecommunications method comprising the stages of:

generating at least two optical transmission signals, at predetermined wavelengths which are different from each other;

multiplexing the said optical signals in a single transmission line, forming a multiple-wavelength optical signal comprising the said optical transmission signals;

transmitting the said multiple-wavelength optical signal by means of the transmission line;

amplifying the said optical signal along the transmission line by means of at least one optical amplifier located along the line;

sending the said optical signal to a receiving station comprising at least one receiver,

characterized in that the said stage of amplifying the said optical signal comprises the stages of:

sending the optical signal received from the line to the input of the amplifier;

separating the amplified optical signal from the spontaneous emission of the amplifier at the output of the amplifier;

sending the said spontaneous emission back to the input of the amplifier;

sending the said amplified optical signal to the line.

According to an embodiment of the present invention, the stage of separating the amplified optical signal from the spontaneous emission of the amplifier at the output of the amplifier comprises the stages of:

selectively reflecting the radiation having a wavelength corresponding to that of the said optical signals;

sending this reflected radiation to the output of the amplifier.

According to an embodiment of the present invention, the stage of sending the spontaneous emission back to the input of the amplifier comprises the further stages of:

collecting the portion of non-reflected radiation corresponding to the spontaneous emission of the amplifier;

attenuating this portion of radiation; and

coupling this attenuated portion of radiation to the input of the amplifier.

A further aspect of the present invention relates to a method for stabilizing the gain of an optical amplifier, comprising the following stages:

sending an optical signal to the input of the amplifier;

sending the said optical signal, when amplified, to the output of the amplifier,

characterized in that it comprises the stages of:

separating the amplified optical signal from the spontaneous emission of the amplifier at the output of the amplifier;

sending the said spontaneous emission back to the input of the amplifier.

### BRIEF DESCRIPTION OF DRAWINGS

Further details can be found in the following description, with reference to the attached figures which show:

FIG. 1: a diagram of a multiple-wavelength telecommunications system;

FIG. 2: a diagram of an optical amplifier;

FIG. 3: an optical amplifier according to one embodiment of the present invention;

FIG. 4: the graph of spectral emission of the active fibre of the amplifier shown in FIG. 2;

FIG. 5: a diagram of an experimental device comprising an optical amplifier according to the present invention;

FIG. 6: the graph of spectral emission at the output of the amplifier of the device shown in FIG. 5, with four channels present, in the absence of a gain control loop;

FIG. 7: the graph of spectral emission at the output of the amplifier of the device shown in FIG. 5, with a single channel present, in the absence of a gain control loop;

FIG. 8: the graph of spectral emission at the output of the amplifier of the device shown in FIG. 5, with four channels present, in the presence of the gain control loop according to the present invention;

FIG. 9: the graph of spectral emission at the output of the amplifier of the device shown in FIG. 5, with a single channel present, in the presence of the gain control loop according to the present invention;

FIG. 10: the graph of the spectrum of the optical signal circulating in the gain control loop;

FIG. 11: a diagram of an experimental device comprising an optical amplifier according to the prior art.

### DETAILED DESCRIPTION OF THE PREFERRED EMBODIMENTS

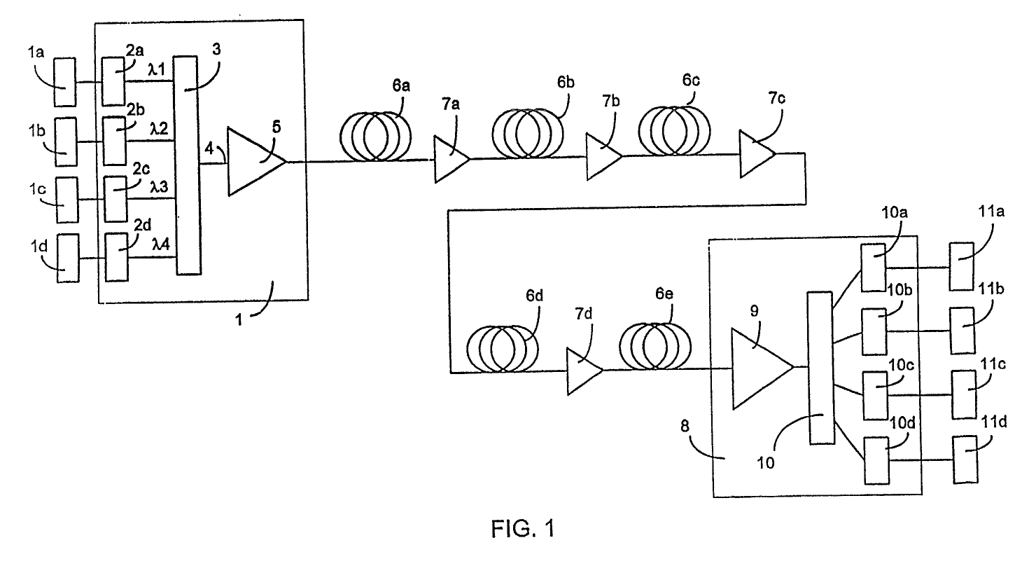

As shown in FIG. 1, an optical telecommunications system with a plurality of channels, of the wavelength division multiplexing type, has a plurality of sources of original signals, four in the illustrated example (1a, 1b, 1c, 1d).

The said signals may be of the electric type, or optical signals, each of which, in this case, may have its own transmission characteristics, such as wavelength, type of modulation, and power. The signals generated by these sources are supplied to a transmission station 1.

In this station, the signals, if they are of the electrical type, are converted into optical form, with characteristics suitable for the transmission system, by means of corresponding optical transmitters, or, if they are already of the optical type, are sent to corresponding interface units 2a, 2b, 2c, 2d capable of receiving the external original optical signals, of detecting them and of regenerating them with new characteristics suitable for the transmission system.

U.S. Pat. No. 5,267,073, held by the present applicant, describes interface units comprising, in particular, a transmission adapter, capable of converting an input optical signal into a form suitable for the optical transmission line, and a receiving adapter, capable of reconverting the transmitted signal into a form suitable for a receiving unit.

Preferably, for use in the system according to the present invention, the transmission adapter of each interface unit comprises a laser of the external modulation type as the output signal generation laser.

Interface units of the type indicated are described in the aforementioned patent and are marketed by the applicant under the trade name TXT/E-EM.

In all cases, the interface units or the optical signal generators present in the transmission station 1 generate corresponding optical operating signals, having wavelengths of λ1, λ2, λ3, λ4, within corresponding channels lying within the pass bands of the amplifiers located in succession in the system.

The said optical operating signals are then supplied to a signal combiner 3 capable of sending the operating signals at the wavelengths λ1, λ2, λ3, λ4 to a single output optical fibre 4 simultaneously. For example, the wavelengths λ1, λ2, λ3, λ4 of the operating signals may be 1535, 1543, 1550, 1557 nm.

In general, the signal combiner 3 is a passive optical device, by means of which the optical signals transmitted along corresponding optical fibres are superimposed in a single fibre; devices of this kind consist, for example, of couplers of the fused fibre, planar optics, micro-optics, and similar types.

By way of example, a suitable combiner is the 1×4 SMTC-0104-1550-A-H combiner marketed by E-TEK Dynamics Inc., 1885 Lundy Ave., San Jose, Calif., USA.

The said operating signals, indicated below as S1, S2, S3 and S4, are sent through the fibre 4 to a power amplifier 5, which raises their level to a value sufficient for passage through the subsequent length of optical fibre located before further amplifier means, ultimately maintaining a sufficient power level to ensure that the required transmission quality is provided.

The amplifier 5 is then connected to a first length 6a of optical line, usually consisting of a single-mode optical fibre, of the stepped-index type, incorporated in a suitable optical cable with a length of several tens (or hundreds) of kilometers, for example about 100 kilometers. Suitable optical fibres are, for example, stepped-index fibres with a dispersion of approximately 17 ps/km at wavelengths around 1550 nm. Lower dispersion values, from 1.5 to 6 ps/km for example, may be obtained with fibres known as NZD fibres, described, for example, in ITU-T Recommendation G. 655.

At the end of the said first length 6a of optical line there is a first line amplifier 7a capable of receiving the signals attenuated during their passage through the fibre, and of amplifying them to a level sufficient to enable them to be supplied to a second length of optical fibre 6b, whose characteristics are similar to those of the preceding length.

Successive line amplifiers 7b, 7c, 7d and corresponding lengths of optical fibre 6c, 6d, 6e, usually also incorporated in corresponding cables, cover the total required transmission distance until a receiving station 8 is reached.

The receiving station 8 may comprise a preamplifier 9 capable of receiving the signals and of amplifying them to a power level suitable for the sensitivity of the receiving devices, with allowance for the losses caused by the signal demultiplexing equipment.

The optical fibres (6a, 6b, 6c, 6d, 6e) used for connections of the type described may be optical fibres of the “dispersion shifted” type.

The types described previously, however, are preferable in cases in which it is desired to avoid or reduce the non-linear effects of intermodulation between adjacent channels, which may be particularly significant in dispersion shifted fibres, particularly if the distance between the channels is very small.

The signals are sent from the preamplifier 9 to a demultiplexer 10, by means of which the signals are separated according to their wavelengths, and then eventually sent to the interface units 10a, 10b, 10c, 10d capable of receiving the optical signals having the characteristics suitable for the transmission system and of regenerating them with the original optical characteristics, in other words with other characteristics which are suitable for the corresponding receiving equipment 11a, 11b, 11c, 11d.

The demultiplexer 10 is a device capable of distributing among a plurality of output fibres the optical signals supplied to an input fibre, by separating them in accordance with their corresponding wavelengths.

This demultiplexer may be a splitter of the fused fibre type, which divides the input signal into signals in a plurality of output fibres, in particular 4 fibres, each of which signals is supplied to a corresponding band-pass filter centred on each of the wavelengths in question.

For example, a component identical to the signal combiner 3 described previously, fitted in the opposite configuration, may be used as the demultiplexer, in combination with corresponding band-pass filters located on the corresponding output fibres.

Band-pass filters of the type mentioned are, for example, marketed by Micron-Optics, Inc., 2801 Buford Hwy, Suite 140, Atlanta, Ga., USA; a suitable model is the FFP-100.

The configuration described is particularly suitable for transmission over distances of the order of approximately 500 km, at high transmission speeds, for example 2.5 Gbit/s (providing, with four multiplexed wavelengths, a transmission capacity equivalent to 10 Gbit/s per single fibre), using four line amplifiers, a power amplifier and a preamplifier.

For the purposes of the present invention and for the application described above, the power amplifier 5 is, for example, an optical fibre amplifier of the commercial type, having the following characteristics:

input power from −5 to +2 dBm

output power 13 dBm

operating wavelength 1530-1560 nm.

A suitable model is the TPA/E-MW marketed by the applicant.

The said amplifier uses an active optical fibre doped with erbium.

The power amplifier operates in conditions of full saturation, in which the output power depends on the pump power, for example as described in detail in European Patent No. EP 439.867.

For the purposes of the present invention, and for the application described above, the term “preamplifier” denotes an amplifier located at the end of the line and capable of raising the signal to be supplied to the receiver to a value suitably higher than the threshold of sensitivity of the receiver (for example from −26 to −11 dBm at the receiver input), while at the same time introducing the minimum possible noise and maintaining the equalization of the signals.

A preamplifier suitable for the purpose is, for example, the RPA-/E-MW model, marketed by the applicant.

The transmission system configuration described above has proved to be particularly suitable for providing the desired performance, particularly for transmission in a plurality of wavelength division multiplexing channels, in the presence of a particular selection of the properties of the line amplifiers which form part of it, particularly in relation to the capacity of transmitting the selected wavelengths without any of them being penalized with respect to the others.

In particular, it is possible to guarantee uniform behaviour for all the channels, in the wavelength band from 1530 to 1560 nm, in the presence of amplifiers suitable for operation in series, by using line amplifiers designed in such a way that they have a substantially uniform (or “flat”) response to the various wavelengths, in operation in series.

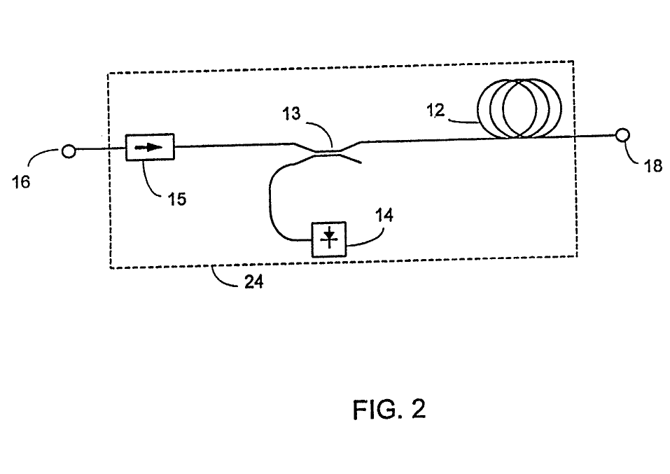

An amplifier may have the circuit shown in FIG. 2.

The amplifier comprises an active fibre 12, doped with erbium, and a corresponding dichroic coupler 13, to which a pumping laser 14 is connected; a photo-isolator 15 is located before the fibre 12, in the direction of the path of the signal to be amplified, which is supplied to the input 16 of the amplifier.

A second photo-isolator, not illustrated, may be located after the fibre 12.

In the example illustrated (but not necessarily), the pumping laser 14 is connected in such a way as to supply pumping energy in the same direction as the signal in the fibre 12.

The pumping laser 14 may be, for example, a laser of the quantum well type, with the following characteristics:

| | |
|---|---|
| emission wavelength | λₚ = 980 nm; |
| maximum output power | Pᵤ = 90 mW. |

Lasers of the type mentioned are produced, for example, by Lasertron Inc., 37 North Avenue, Burlington, Mass., USA.

The dichroic coupler 13 may be, for example, a fused fibre coupler, formed from single-mode fibres at 980 and in the 1530-1560 nm wave band.

Dichroic couplers of the type mentioned are known and marketed, and are produced, for example, by E-TEK Dynamics Inc., 1885 Lundy Ave., San Jose, Calif., USA, or by Gould Inc., Fibre Optic Division, Baymeadow Drive, Glem Burnie, Md., USA, or SIFAM Ltd., Fibre Optic Division, Woodland Road, Torquay, Devon, UK.

The photo-isolator 15 is a photo-isolator of the type which is independent of the polarization of the transmission signal, preferably with an isolation of more than 35 dB and reflectivity of less than −50 dB.

A suitable isolator is, for example, the PIFI 1550 IP02 model made by the aforesaid E-TEK Dynamics, or the MDL.

I-15 PIPT-A S/N 1016 model made by the company Isowave, 64 Harding Avenue, Dover, N.J., USA.

In the system described, the line amplifiers, conveniently made in a two-stage configuration, are designed for operation with a total output optical power of approximately 14 dBm, with a gain of approximately 30 dB.

The applicant has made different types of active fibres doped with erbium for use in amplifiers for multiple-wavelength systems, as described in detail in European Patent Application EP 677902 filed by the present applicant.

The composition and optical characteristics of a preferred fibre of the fibres in question are summarized in Table 1 below:

TABLE 1

| Al₂O₃ | | GeO₂ | | La₂O₃ | | Er₂O₃ | | | |
|---|---|---|---|---|---|---|---|---|---|
| % | (% | % | (% | % | (% | % | (% | | λ_{c} |
| p | mol) | p | mol) | p | mol) | p | mol) | NA | nm |
| 4 | (2.6) | 18 | (11.4) | 1 | (0.2) | 0.2 | (0.03) | 0.22 | 911 |

in which:
% p = percentage content of oxide by weight in the core (mean)
% mol = percentage content of oxide in moles in the core (mean)
NA = numerical aperture (n₁² − n₂²)^{1/2}
λ_{c} = cut-off wavelength (LP₁₁ cut-off).

The analyses of the compositions were carried out on a preform (before the spinning of the fibre), by means of a microprobe combined with a scanning electron microscope (Hitachi SEM).

The analyses were carried out at a magnification of 1300 at discrete points located along a diameter and spaced at 200 μm from each other.

The fibre mentioned above was made by the method of chemical deposition in the vapour phase inside a quartz glass tube; the germanium was incorporated as the dopant in the SiO₂ matrix of the fibre core during the synthesis, while the erbium, aluminium and lanthanum were incorporated into the fibre core by means of what is called the “doping in solution” method, in which an aqueous solution of chlorides of the dopants is brought into contact with the material for the synthesis of the fibre core, while the material is in the particulate state, before the consolidation of the preform.

Further details of the method of doping in solution may be found, for example, in U.S. Pat. No. 5,282,079.

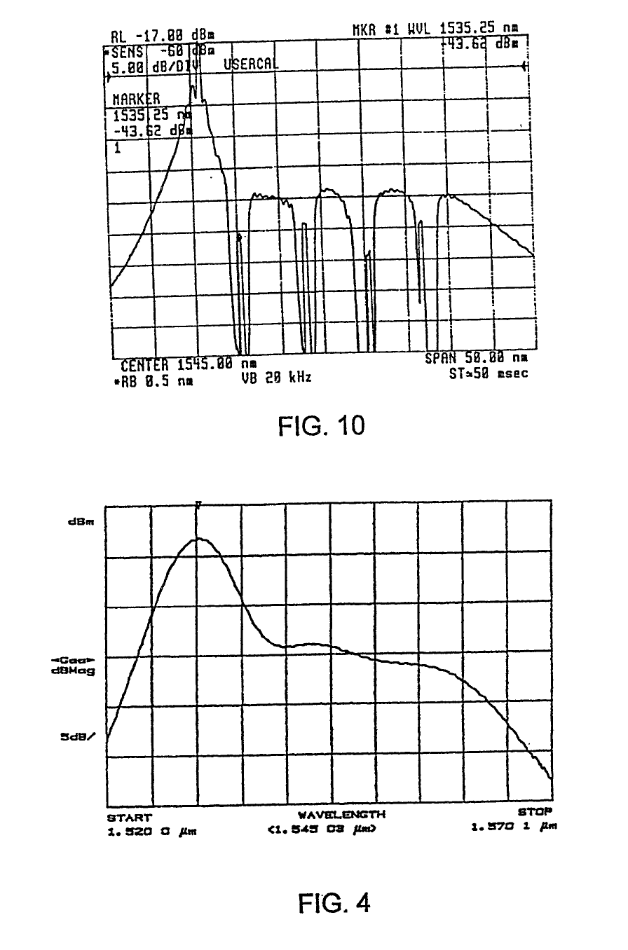

The typical emission spectrum of the fibre in question is shown in FIG. 4.

An amplifier of the type described above is indicated below as the amplification unit 24.

B) Gain control

In the system described above, the signals transmitted from the various sources are generally amplified in a substantially uniform way, as a result of the particular characteristics of the amplifiers.

In particular conditions, for example in the presence of random switching on and off of one or more of the sources, and consequently in the presence of a variable number of channels supplied simultaneously to the line and to the amplifiers, there are variations of the optical power value between the amplifiers, which may result in variations of gain of the amplifiers such that the quality of the transmission is degraded.

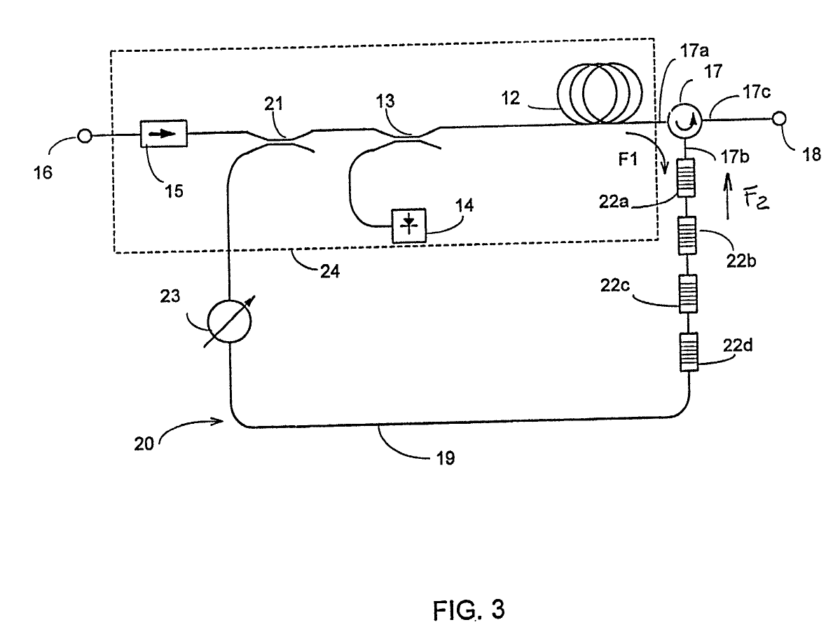

According to the present invention, a gain stabilization circuit, one embodiment of which is illustrated in FIG. 3, is associated with the amplifier as described above (or with its equivalent alternatives).

The stabilization circuit associated with the amplification unit 24 comprises an optical circulator 17, connected after the active fibre 12 of the amplification unit 24 by a corresponding connecting fibre 17a, and connected to the output port 18 of the amplifier by the connecting fibre 17c opposite the previous one. The intermediate connecting fibre 17b of the optical circulator is connected to the fibre 19 of a loop circuit 20.

The opposite end of the fibre 19 of the loop circuit 20 is connected through a coupler 21 to the input of the amplification unit 24, before the active fibre 12; preferably, but not necessarily, the loop circuit is connected before the dichroic coupler 13 with respect to the direction of travel of the transmission signals in the amplifier.

Preferably, the coupler 21 is a coupler of the directional type, having a predetermined separation ratio.

The loop circuit 20 comprises a plurality of selective reflection filters 22, for example four, as shown in the figure, arranged in series along the fibre 19 and indicated by 22a, 22b, 22c, 22d respectively.

In one embodiment, an adjustable attenuator 23 is also connected in the loop.

The number of the selective reflection filters 22 is preferably not less than the number of channels which can be transmitted, and more preferably equal to the latter, and each filter reflects at least one corresponding wavelength of the said channels.

Each of the said filters consists of a portion of an optical waveguide, for example an optical fibre, along which the refractive index shows a periodic variation, and there is a partial signal reflection at the point of the said variation of the index: if the portions of signal reflected at each change of index are in phase with each other, there is constructive interference and the incident signal is reflected.

The condition of constructive interference, corresponding to the maximum reflection, is expressed by the relation 2·1=λₓ/n, where 1 indicates the interval of the grating formed by the variations of the refractive index, λₛ is the wavelength of the incident radiation and n is the refractive index of the core of the optical waveguide. The phenomenon described is referred to in the literature as distributed Bragg reflection.

The periodic variation of the refractive index can be obtained by known methods, for example by exposing a portion of optical fibre, from which the protective polymer coating has been stripped, to the interference fringes formed by an intense UV beam (such as that generated by an excimer laser, a frequency-doubled argon laser or a frequency-quadrupled Nd:YAG laser) made to interfere with itself by means of a suitable interferometry system, for example by means of a silicon phase mask, as described in U.S. Pat. No. 5,351,321.

The fibre, and in particular the core of the fibre, is thus exposed to UV radiation whose intensity varies periodically along the optical axis. In the parts of the core reached by the UV radiation of maximum intensity, a partial breaking of the Ge-O bonds occurs, causing a permanent modification of the refractive index.

By selecting the interval of the grating in such a way that the relation of constructive interference is present, it is possible to determine the central wavelength of the reflected band as desired, according to known criteria.

By this method it is possible, for example, to obtain filters with a band at −3 dB of reflected wavelength of the order of 0.2-0.3 nm, a reflectivity of up to approximately 100% at the centre of the band, a central wavelength of the reflected band which can be determined during manufacture with an accuracy of approximately ±0.1 nm and a variation of the central wavelength of the band with temperature of not more than 0.02 nm/°C.

If the wavelengths of the sources 1a, 1b, 1c, 1d have a tolerance range of more than 0.2-0.3 nm, it is convenient to have filters with a pass band of corresponding width, in order to include the emission wavelength of the sources within the band reflected by the filters.

For example, in the case of sources consisting of semiconductor lasers of the commercial type, the emission wavelength is typically determined by selecting the lasers with emission in the range of ±1 nm with respect to the central wavelength required, or, by temperature tuning, down to ±0.5 nm or even below, for example ±0.1 nm. It is possible to envisage the manufacture of gratings with a wide reflected band, sufficient to reflect two or more channels spaced by multiples or sub-multiples of a standard spacing.

In such cases it is possible to make optical fibre filters of the distributed Bragg reflection type with a sufficiently wide reflected band, for example by specifying a variable interval for the grating, thus forming what is called a “chirped” grating. This grating can also be used, if necessary, as a dispersion compensator.

For this purpose it is possible to use methods known, for example, from the article by P. C. Hill et al., published in Electronics Letters, vol. 30, No. 14, Jul. 7, 1994, pp. 1172-1174.

In general, for the purposes of the present invention, a filter with selective reflection at the wavelength λ of one of the communication signals in a wavelength division multiplexing communication system is taken to mean an optical component capable of reflecting a substantial fraction of the radiation with a wavelength lying within a predetermined wave band, and of transmitting a substantial fraction of the radiation with a wavelength lying outside this predetermined band, where this predetermined wave band includes at least the wavelengths of a communication channel and excludes the remaining wavelengths of the other communication channels.

Filters of the above type are, for example, marketed by Photonetics S. A., France, under the trade name GRAF-.

For brevity, the selective reflection filters will be referred to as “selective filters” in the following text.

The directional coupler 21 has a predetermined coupling ratio; a suitable coupling ratio is selected, as described below, according to the specified operating conditions of the circuit.

Suitable directional couplers, of the single-mode fused fibre type, available with different values of the predetermined coupling ratio, are marketed by E-TEK Dynamics.

The attenuator 23, if present, is preferably a single-mode 1550 nm low-reflection attenuator, for example the VA5 or MV47 model made by the JDS Company.

The optical circulator 17 is a passive optical component, generally provided with three or four access ports in an ordered sequence (17a, 17b, 17c), which transmit, in a unidirectional way, the radiation entering from one port towards the next port in the sequence.

The circulator used is preferably of the type having a response which is independent of the polarization.

Optical circulators are commercially available components. Examples of models suitable for use in the present invention are the CR1500 produced by JDS FITEL Inc., 570 Heston Drive, Nepean, Ontario, Canada, or the PIFC-100 produced by the aforementioned E-TEK Dynamics.

Instead of the optical circulator it is possible to use an optical splitter, for example one of the fused fibre type having one of the terminated fibres with low reflection. This device is cheaper but is less desirable in terms of signal attenuation.

The amplifier described operates in the following way.

The signals at the input of the amplifier are amplified in the fibre 12, pumped by the laser 14, and supplied to the fibre 17a which enters the circulator 17.

In the circulator 17 the signals are switched to the fibre 17b; they pass from this fibre to the selective filters 22, in the direction shown by the arrow F1.

The selective filters 22 reflect the wavelengths corresponding to the specified transmission channels, for example 1535, 1543, 1550, 1557 nm, and the signals at these wavelengths reflected in the direction of the arrow F2 are then sent back to the fibre 17b of the circulator 17, which in turn sends them to its output fibre 17c.

The active fibre 12, pumped by the laser 14, has a spontaneous emission (hereafter termed “ASE”), illustrated in FIG. 4, which is superimposed on the spectrum of the channels present.

The action of the selective filters 22 modifies the spectrum of the total signal after the filters, which circulates in the loop 20 in the direction of the arrow F1 and is fed back to the coupler 21, substantially eliminating the signals and leaving only the spontaneous emission.

The portion of the signal spectrum propagated in the direction of the arrow F1, consisting substantially of ASE (amplified spontaneous emission of the active fibre) then passes through the loop 20 and is again supplied to the active fibre 12.

In suitable conditions, as defined below, the loop 20 and the active fibre 12 can form a loop laser system, oscillating at a wavelength lying within the ASE spectrum, and different from those reflected by the selective filters 22.

When all the transmission channels are present at the input of the amplifier, the pump power supplied to the fibre 12 of the amplification unit 24 is used to amplify the signals, and the corresponding level of ASE is kept relatively low; the characteristics of the amplification unit 24, and in particular the erbium doping in the fibre 12, the length of the fibre 12 and the pump power supplied, are predetermined for operation at the typical design values for the line in this condition (with all the transmission channels present at the input of the amplifier).

Typically, there will be a gain “from fibre to fibre” whose value generally lies in the range 20-30 dB and a total output power of the order of approximately 10-14 dBm.

If one or more channels are switched off, there is a lower total signal power level in the active fibre; this results in a lower pump power consumption in the active fibre 12 (the power no longer being absorbed by the amplification of the absent channels), and the consequent greater availability of pump power supplied causes a greater emission of ASE in the fibre, which is totally re-circulated in the loop 20.

This ASE, being re-injected into the fibre 12 by the directional coupler 21, is superimposed on the signals present, and its amplification in the fibre 12 decreases the pump power available for the amplification of the transmission channels which are present, and consequently limits the gain of these channels.

When the absent channels are reconnected, their amplification in the active fibre consumes the available pump power, and this correspondingly results in a reduction of the level of ASE fed back in the loop.

In this way the gain in all the channels is kept substantially constant, even in the presence of a variable number of channels in the amplifier.

The level of ASE circulating in the loop 20 is regulated in a substantially automatic way in accordance with the number of channels present, and the ASE itself absorbs the excess pump power which would be available when some of the channels are absent, leaving a substantially constant available pumping level in all conditions for the channels which are present.

The spontaneous emission is separated from the channels by filtering each wavelength of the channels, as described previously. If the channels to be amplified are very close to each other, thus making separation by point filtering difficult, the spontaneous emission can be separated from the channels by means of a wide band filter which separates the band containing all the channels from the remaining spectrum at wavelengths higher than the highest wavelength of the channels and lower than the lowest.

### EXAMPLE 1

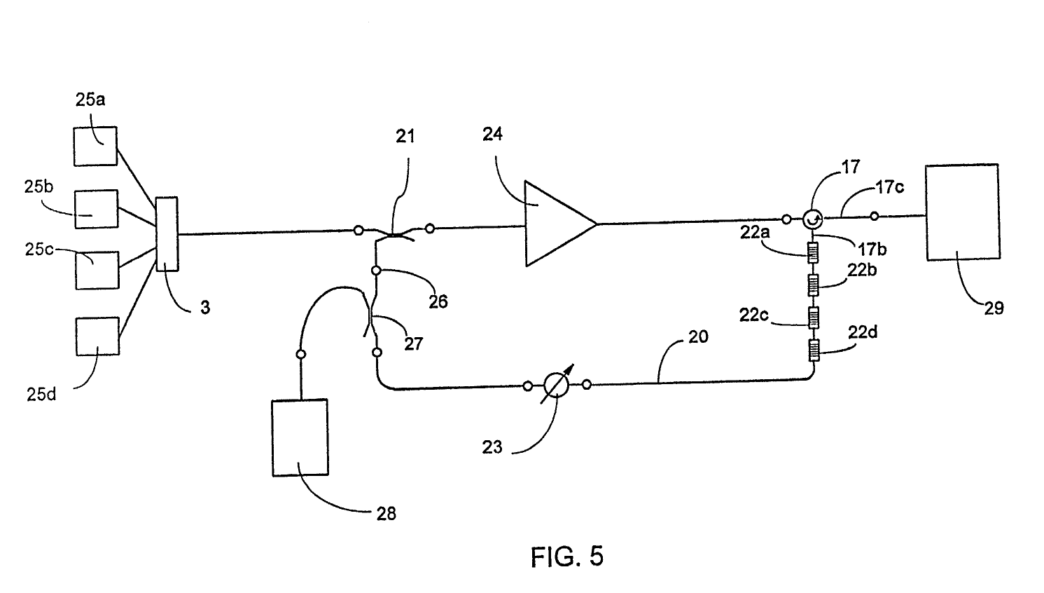

In order to verify the effectiveness of the solution which had been identified, an experimental configuration of a device according to the invention was set up, as illustrated in FIG. 5.

In this configuration, four signal sources 25a, 25b, 25c, 25d were provided, combined by a multiplexer 3 and connected to the input of an amplification unit 24.

The output of the unit 24 was connected to an optical circulator 17, whose output 17b was connected to a feedback loop 20, comprising the selective filters 22a, 22b, 22c, 22d and a variable attenuator 23.

The end 26 of the feedback loop 20 was connected to the input of the amplification unit 24 by means of a directional coupler 21 of the 95/5 type.

The loop 20 also comprised a directional coupler 27, of the 50/50 type, connectable to an optical spectrum analyser 28.

A second optical spectrum analyser 29 was also connectable to the output 17c of the circulator 17.

In the experiment which was conducted, the amplification unit 24 consisted of a two-stage optical amplifier, model OLA/E-MW, marketed by the applicant, which had the following nominal characteristics:

| | | |
|---|---|---|
| pump power | 65-75 | mW; (two pumping lasers) |
| gain | 22-30 | dB per channel; |
| total output power | 12-14 | dBm |
| total input power | −20/−9 | dBm |

The signal sources 25 had emission wavelengths λ1, λ2, λ3 and λ4 of 1535, 1543, 1550 and 1557 nm respectively, and the selective filters 22 were centred on these wavelengths. The selective filters used were, respectively, models GRAF-1535-0030-1B, GRAF-1543-0030-1B, GRAF-1550-0030-1B, GRAF-1557-0030-1B, produced by the aforementioned Photonetics company, having a bandwidth of approximately 3 nm at −3 dB.

The signal at the amplifier input had a total power Pᵢₙ₍ₜₒₜ₎ of −14 dBm, corresponding to a power per channel P_{in(ch)} of −20 dBm (±1 dB).

In order to make the measurements described above, the connection of the end 26 of the loop 20 to the coupler 21 could be removed, thus providing a measurement of the performance of the amplifier in the absence of the feedback loop.

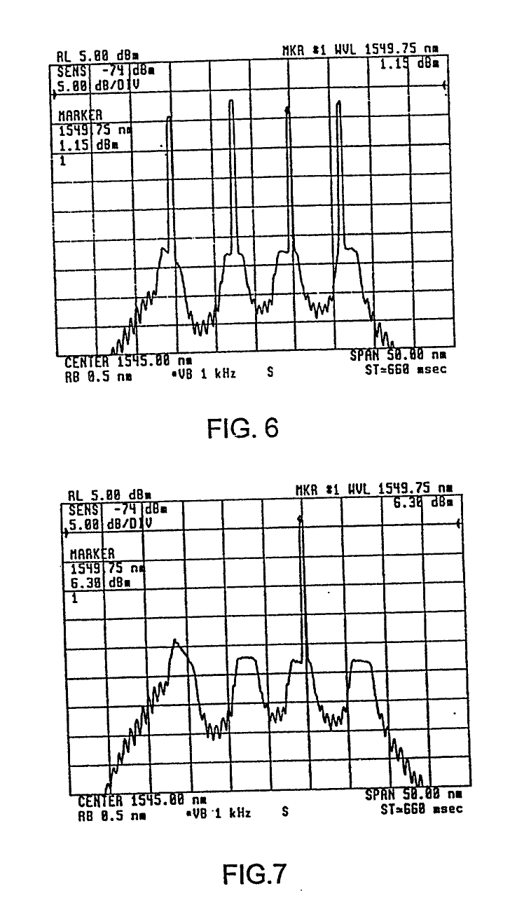

A spectrum at the output of the amplifier, determined by the spectrum analyser 29 in open loop conditions and in the presence of all the signals, is shown in FIG. 6.

In this condition, the presence of the circulator 17 and of the selective filters 22 makes it possible have only the signals at the output, while the noise, and in particular the ASE, is greatly attenuated.

The peak power of one of the signals, taken as the reference level (λ3=1549.75 nm) was found to be 1.15 dBm, corresponding to a gain of approximately 21 dB for the single channel, while the total gain of the loop was approximately 30 dB, corresponding to the gain of the OLA around a wavelength of 1530 nm.

Owing to the characteristics of the amplifier used, the gain for the different signals was found to be substantially uniform.

The sources at λ1, λ2 and λ4 were then switched off and the spectrum corresponding to the output of the amplifier, shown in FIG. 7, was determined, again in open loop conditions.

As shown by the diagram, the peak power at the amplifier output was found to be 6.3 dBm and the corresponding gain was 26.3 dB, considerably larger than the preceding value.

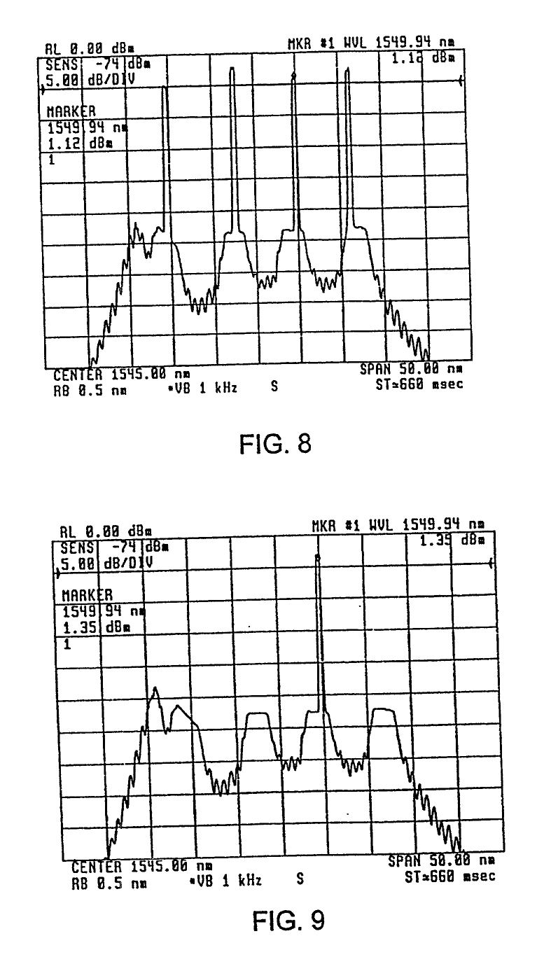

The loop was then closed, and the measurements were repeated, in the presence of the four sources at λ1, λ2, λ3 and λ4, and in the presence of the source at λ3 only, the spectra for these being shown in FIGS. 8 and 9.

The attenuation of the loop was set to approximately 30 dB by means of the variable attenuator 23 (with allowance for the attenuation caused by the coupler 27).

As shown in the figures, in the presence of four channels the closing of the loop caused no significant change of the spectrum by comparison with the preceding case, a peak power of 1.12 dBm being measured for the reference channel; this power is practically equal to that for the open loop. In the presence of only one input channel, the peak power for the single channel present was found to be 1.35 dBm, showing a negligible variation of gain with respect to the case of four channels (less than 10%).

The spectrum of the total optical signal re-circulating in the loop 20 in the experimental conditions used was determined by means of the analyser 28 and is shown in FIG. 10.

### EXAMPLE 2

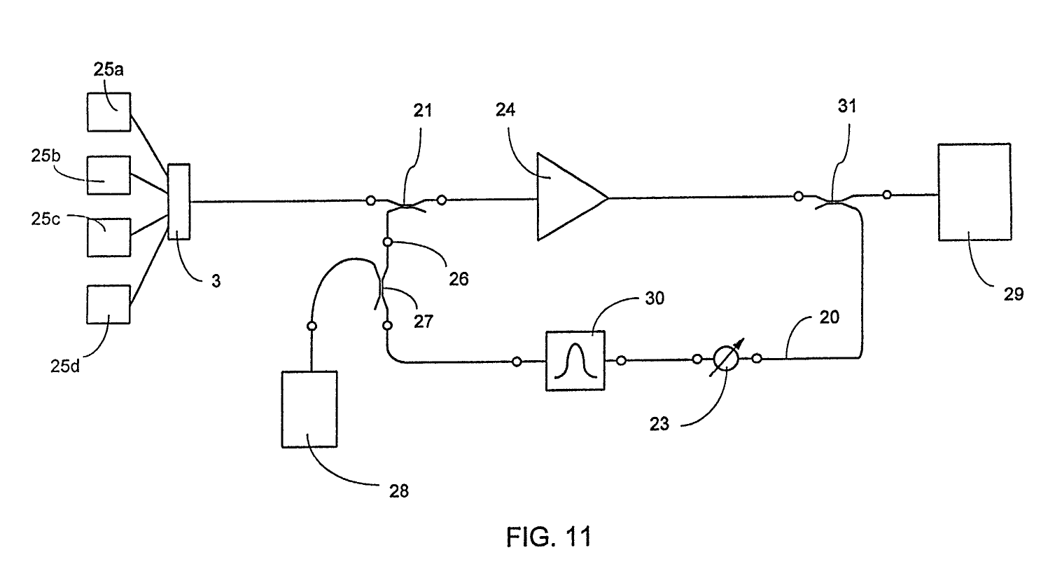

In order to evaluate the performance of the amplifier according to the invention, a comparison experimental structure was produced with the configuration shown in FIG. 11, in which an interference filter 30 was used in place of the selective filters 22a, 22b, 22c and 22d of the structure shown in FIG. 5, and the feedback loop was connected to the output of the amplification unit 24 by means of a directional coupler 31 of the 50/50 type.

Two tunable band-pass interference filters, made by JDS and having the following characteristics, were tested.

| | | |
|---|---|---|
| Filter 1: | | |
| Bandwidth at −3 dB | BW1_{(-3 dB)} | 3.3 nm |
| Bandwidth at −20 dB | BW1_{(-20 dB)} | 11.4 nm; |
| Filter 2: | | |
| Bandwidth at −3 dB | BW2_{(-3 db)} | 1.6 nm |
| Bandwidth at −20 dB | BW1_{(-20 db)} | 5.5 nm. |

The feedback loop was made to oscillate at 1530.8 nm by tuning the interference filter to this wavelength.

Successive measurements were made with different loop loss values, from 26 to 30 dB.

The results of the measurements are shown in Table 2 below.

TABLE 2

| | | Filter 1 | | | Filter 2 | | |
|---|---|---|---|---|---|---|---|
| | Loop | Po(4) | Po(1) | | Po(4) | Po(1) | |
| | atten. | (dBm) | (dBm) | notes | (dBm) | (dBm) | notes |
| A | open | −5.47 | −0.84 | — | 0.44 | 3.75 | — |
| B | 26 dB | — | — | — | −3.34 | −3 | lasing peak higher |
| | | | | | | | than the channels |
| C | 27 dB | — | — | — | −2.85 | −1.62 | gain control |
| | | | | | | | incomplete |
| D | 28 dB | −6.13 | −6.31 | lasing peak higher | −2.66 | −2.14 | lasing peak higher |
| | | | | than the channels | | | than the channels |
| E | 28 dB | −6.9 | −5.61 | unstable condition | — | — | — |
| | | | | (no lasing) | | | |
| F | 30 dB | −6.26 | −4.65 | gain control | −1.51 | −0.03 | gain control |
| | | | | incomplete | | | incomplete |
| G | 30 dB | −7.45 | −4.69 | gain control | — | — | — |
| | | | | incomplete | | | |

Po(4) = Output power in one channel with four channels present
Po(1) = Output power in one channel with only one channel present

It should be noted that, in this example, by comparison with the preceding one in which the ASE was re-circulated at wavelengths different from those of the signals, the gain control operates with a loop attenuation that decreases (stronger feedback) as the band of the filter becomes narrower. Moreover, in the second example the gain is “clamped” at lower values than those of the gain with the loop open.

In the device according to the invention, the gain control is obtained with loop attenuation close to the amplifier gain (approximately 30 dB), while in this case the gain control is possible only with a lower loop attenuation.

The marked sensitivity of the system, in the open loop condition, to the presence of all or only one of the channels should be noted; even when the loop is present, the possibility of achieving effective gain control is limited.

In particular, it should be noted that, when an effective gain control is achieved (case B for filter 2 and D for filter 1), there is an oscillation (lasing) peak whose intensity is equal to or greater than that of the transmission channels, so that an undesired reduction of the output power is caused. If not eliminated, this oscillation peak would also be amplified in the following line amplifiers, adversely affecting their operation.

The applicant has also observed that the instability of the lasing phenomenon in the structure according to Example 2 is greater than in the structure according to the invention.

The complete re-circulation of the spontaneous emission in the loop, according to the present invention, generates a lasing peak which, as can be seen in the graph in FIG. 10, is much lower (approximately −12 dBm) than the lasing peaks observed with the configuration of Example 2. This results in greater controllability of the amplification in cases in which the channels of the WDM signal decrease or increase in number.

The system shown in FIG. 3 may be designed on the basis of the following conditions:

| | |
|---|---|
| Pᵢ = | −18 dBm; |
| P_{ASE} = | −24 dBm; |
| Pᵢₙ^{tot} = | −17 dBm. |

If g* and α are the coefficients of gain and attenuation of the active fibre, L is its length and \overline{n}₂ is the population factor of the excited level, the gain is given by:

G=e^{[(g*+α)\overline{n}}^{₂}^{-α]•L}

The laser effect is present when:

G/Aₗₒₒₚ=1, where Aₗₒₒₚ is the loop attenuation (or loss);

therefore e^{[(g*+α)n}^{₂}^{-α]•L}/Aₗₒₒₚ=1,

and consequently

$${\overline{n}}_{2} = \frac{α}{( {g}^{*} + α )} + \frac{10 log {A}_{loop}}{10 \cdot L \cdot log e ( {g}^{*} + α )} , \\ \text{and, also taking into account the background loss} γ \text{:}$$

$${\overline{n}}_{2} = \frac{α + γ}{( {g}^{*} + α )} + \frac{10 log {A}_{loop}}{4.34 \cdot L \cdot ( {g}^{*} + α )} ,$$

\overline{n}₂ can be used to determine, in addition to the gain G, the noise figure NF=2\overline{n}ₛₚ, where the inversion factor \overline{n}ₛₚ is given by:

$${\overline{n}}_{sp} = \frac{{N}_{2}}{{N}_{2} - {N}_{1}} = \frac{{\overline{n}}_{2}}{{\overline{n}}_{2} - {\overline{n}}_{1}} = \frac{{\overline{n}}_{2}}{2 {\overline{n}}_{2} - 1} .$$

It should be noted that when the loop loss Aₗₒₒₚ is increased the noise figure NF decreases.

The present invention can operate with higher loop losses Aₗₒₒₚ than in the prior art for the same oscillation λ and for the same characteristics of the optical amplifier (such as L, g* and α) and therefore enables a smaller noise figure to be obtained.

With the values of Example 1 shown above, according to the present invention, we find:

G≅30 dB, and therefore Aₗₒₒₚ(dB)≅30 dB

γ_{dB/m}≅0.22 dB/m (neglibible)

(g*)_{dB/m}≅3.6 dB/m; g*=0.83 m⁻¹

(α)_{dB/m}≅6.0 dB/m; α=1.38 m⁻¹

L≅10 m, and therefore

$${\overline{n}}_{2} ≅ \frac{1.38}{0.83 + 1.38} + \frac{30}{10 \cdot 4.34 \cdot ( 0.83 + 1.38 )} ≅ 0.625 + 0.313 ≅ 0.938 ;$$

\overline{n}ₛₚ≅1.07, NF≅3.30 dB.

(internal noise figure of the amplifier which does not take into account the input injection losses; theoretical minimum NF=3 dB).

With the values of the comparison Example 2 shown above, in particular Aₗₒₒₚ=26 dB, we obtain \overline{n}₂=0.896, and therefore \overline{n}ₛₚ≅1.13, NF≅3.55 dB.

For a loop attenuation value Aₗₒₒₚ=20 dB, on the other hand, we obtain \overline{n}₂=0.834, and therefore \overline{n}ₛₚ≅1.25, NF≅3.98 dB.

The directional coupler 21 may conveniently have a separation ratio in the range from 99/1 to 90/10, in order to contain the attenuation caused in the channels; on the basis of the total attenuation of the components present in the loop 20, it is possible to predetermine the adjustment to be made to the variable attenuator 23, in other words to predetermine a fixed value of attenuation to be introduced.

Additionally, in the configuration of the two-stage amplifier, however, the first stage is also preferably connected within the loop.

For the purposes of the present invention, the term “equalization” denotes bringing all the channels present at one time, and having different wavelengths, to a final output power which is substantially identical in all of them, independently of the input power, within the desired tolerance (for example, output powers differing by less than 1 dB for corresponding differences of 6 dB in the input powers).

The amplifier according to the present invention is particularly suitable both for use as a line amplifier and for use as a preamplifier or power amplifier, since it generates a stabilization of the output signal, for loop gain values Aₗₒₒₚ of >20 dB, which differ by less than 1 dB when the variation of the input signal exceeds 6 dB. Although the amplifier has been described in association with a multiple-wavelength transmission system, advantages in terms of stabilization of the gain and/or of the output power are also apparent in the amplification of a signal with a single wavelength. An amplifier according to the present invention suitable for this application may comprise, for example, a selective reflection circuit with a single grating having a reflected band centred on the said single wavelength.

In particular, the term “line amplifier” denotes an amplifier having a relatively low input power per channel, for example around −20 dBm, so that in at least a significant portion of its active fibre the amplifier operates in conditions of partial saturation; typically, this occurs in an amplifier located after a sufficiently long fibre path, for example one measuring a few tens to a hundred kilometers or so, having a gain of at least 15-20 dB, and therefore capable of supplying sufficient output power to pass along a similar length of fibre path. Such an amplifier should preferably introduce a low level of noise into the system.

The term “power amplifier” denotes an amplifier in which the input power level is such as to cause it to operate in saturation conditions, such that the output power is not substantially affected by the input power; a typical application of a power amplifier is in the proximity of a signal source, or at the start of an optical line, in which the input power, already relatively high, for example between −5 and 0 dBm, has to be raised to a level sufficient for passage along the fibre provided after the amplifier.

The term “preamplifier” denotes an amplifier capable of receiving a signal at relatively low power (for example −20/−30 dBm) and increasing its power with a certain gain up to the sensitivity level of the connected receiving equipment, for example −11/−26 dBm; such an amplifier should preferably introduce a low level of noise into the system.

The constructional characteristics of the amplifier according to the present invention may be selected by a person skilled in the art, in accordance with the planned application, as mentioned previously.

I claim:

1. Optical telecommunications system, comprising:
(a) a station (1) for transmitting optical signals, comprising a transmission signals generator (2), capable of generating at least two signals at wavelengths lying within a band of predetermined width, and a multiplexer (3) of the said optical signals;
(b) a station (8) for receiving the said optical signals;
(c) an optical fibre line connecting the said multiplexer of the transmission station to the said receiving station;
(d) the said optical fibre line including at least one optical amplifier (7) comprising at least one fibre (12) doped with a rare earth, at least one source of pumping radiation (14) for the said doped fibre, and a gain stabilization circuit, characterized in that the said gain stabilization circuit includes:
(i) a separator of the transmission signals from the spontaneous emission of the amplifier, connected after the said doped fibre and capable of sending the said transmission signals to one output of the amplifier and the said spontaneous emission to a further output;
(ii) a loop circuit for the re-circulation of the said spontaneous emission collected from the said further output and re-injected before the said doped fibre of the amplifier.

2. Optical telecommunications system according to claim 1, characterized in that the said signal separator comprises an optical circulator (17), connected after the doped fibre (12) of the amplifier by a connecting fibre (17a) and to the output port (18) of the amplifier by a connecting fibre (17c) opposite to the previous one, and having an intermediate connecting fibre (17b) connected to a selective reflection filtering station which reflects along the said fibre the signals having wavelengths equal to those of the transmission signals and sends the remaining radiation to the said loop circuit.

3. Optical telecommunications system according to claim 1, characterized in that the said loop circuit comprises a length of optical fibre (19) having one end connected to the output of the said filtering station and the other end connected, through a coupler (21), before the doped fibre (12) of the amplifier.

4. Optical telecommunications system according to claim 3, characterized in that the said loop circuit comprises a variable attenuator (23) connected along the length of optical fibre (19).

5. Optical telecommunications system according to claim 2, characterized in that the said filtering station comprises at least one selective reflection filter (22), tuned to one or more wavelengths of the said at least two transmission signals.

6. Optical amplifier (7) comprising:
an input port for an optical signal to be amplified;
at least one fibre (12) doped with a rare earth;
at least one source of pumping radiation (14) for the said doped fibre;
an output port for an amplified signal; and
a gain stabilization circuit, characterized in that the said gain stabilization circuit includes:
(i) a separator of the amplified signal from the spontaneous emission of the amplifier, connected after the said doped fibre and capable of sending the said transmission signal to the output port of the amplifier and sending the said spontaneous emission to a further output; and
(ii) a loop circuit for re-circulating the said spontaneous emission collected from the said further output and re-injected before the said doped fibre of the amplifier.

7. Amplifier according to claim 6, characterized in that the said signal separator comprises an optical circulator (17), connected after the doped fibre (12) of the amplifier by a connecting fibre (17a) and to the output port (18) of the amplifier by a connecting fibre (17c) opposite to the previous one, and having an intermediate connecting fibre (17b) connected to a selective reflection filtering station which reflects the signals having wavelengths equal to those of the transmission signals to the said intermediate connecting fibre, and sends the remaining radiation to the said loop circuit.

8. Amplifier according to claim 6, characterized in that the said loop circuit comprises a length of optical fibre (19) having one end connected to the output of the said filtering station and the other end connected, through a coupler (21), before the doped fibre (12) of the amplifier.

9. Amplifier according to claim 8, characterized in that the said loop circuit comprises a variable attenuator (23) connected along the length of fibre (19).

10. Amplifier according to claim 7, characterized in that the said filtering station comprises at least one selective reflection filter (22), tuned to the wavelength of the said signal to be amplified.

11. Optical telecommunications method comprising the stages of:
(a) generating at least two optical transmission signals, at predetermined wavelengths which are different from each other;
(b) multiplexing the said optical signals in a single transmission line, forming a multiple-wavelength optical signal comprising the said optical transmission signals;
(c) transmitting the said multiple-wavelength optical signal by means of the transmission line;
(d) amplifying the said optical signal along the transmission line by means of at least one optical amplifier located along the line;
(e) sending the said optical signal to a receiving station comprising at least one receiver, characterized in that the said stage of amplifying the said optical signal includes the stages of:
(i) sending the optical signal received from the line to the input of the amplifier;
(ii) separating the amplified optical signal from the spontaneous emission of the amplifier at the output of the amplifier;
(iii) sending the said spontaneous emission back to the input of the amplifier;
(iv) sending the said amplified optical signal to the line.

12. Method according to claim 11, characterized in that the said stage of separating the amplified optical signal from the spontaneous emission of the amplifier at the output of the amplifier comprises the stages of:
(a) selectively reflecting the radiation having a wavelength corresponding to that of the said optical signals;
(b) sending this reflected radiation to the output of the amplifier.

13. Method according to claim 12, characterized in that the said stage of sending the said spontaneous emission back to the input of the amplifier comprises the further stages of:
(a) collecting the portion of non-reflected radiation corresponding to the spontaneous emission of the amplifier;
(b) attenuating this portion of radiation; and
(c) coupling this attenuated portion of radiation to the input of the amplifier.

14. Method for stabilizing the gain of an optical amplifier, comprising the following stages:
(a) sending an optical signal to the input of the amplifier;
(b) sending the said optical signal, when amplified, to the output of the amplifier, characterized in that it comprises the stages of:
(c) separating the amplified optical signal from the spontaneous emission of the amplifier at the output of the amplifier; and
(d) sending the said spontaneous emission back to the input of the amplifier.
